(19) United States
(12) Patent Application Publication
(10) Pub. No.: US 2023/0016613 A1
(43) Pub. Date: Jan. 19, 2023

(54) TERMINAL FOR CONNECTING ELECTRIC WIRES AND CONNECTOR USING THE SAME

(71) Applicant: ALPHAO. CO.LTD., Hanam-si, Gyeonggi-do (KR)

(72) Inventor: Young Hwan LEE, Hanam-si, Gyeonggi-do (KR)

(21) Appl. No.: 17/639,610

(22) PCT Filed: Jun. 17, 2021
(86) PCT No.: PCT/KR2021/007579

§ 371 Date: Sep. 7, 2022

(30) Foreign Application Priority Data
Jul. 2, 2020 (KR) 10-2020-0081324
Jun. 10, 2021 (KR) 10-2021-0075462

(51) Int. Cl. H01R 4/2454; H01R 4/2404; H01R 13/516

(52) U.S. Cl. CPC H01R 4/2454; H01R 4/2404; H01R 13/516

(57) ABSTRACT

A terminal for connecting electric wires and a connector using the same provide a terminal which includes a main body part having a band shape, a first connection part, and a second connection part and in which the first and second connection parts are curved at a right angle to each other so that electric wires are connected in the state in which the electric wires are intersected and arranged at a right angle to each other. Accordingly, a flow of a current can be branched through a simple terminal structure. As a result, a current can be supplied to various supply places through the minimum part.

### CROSS-REFERENCES TO RELATED APPLICATIONS

This application is based on and claims priority under 35 U.S.C. 119 to Korean Patent Application Nos. 10-2020-81324, filed on Jul. 2, 2020 and 10-2021-75462, filed on Jun. 10, 2021 in the Korean intellectual property office, the disclosures of which are herein incorporated by reference in their entireties.

### TECHNICAL FIELD

The present disclosure relates to a terminal for connecting electric wires and a connector using the same, and more particularly, to a terminal for connecting electric wires, wherein electric wire arrangement parts having electric wires disposed therein form a right angle to each other and core seated parts for an electric wire connection, which are applied to the electric wire arrangement parts, also form a right angle to each other so that the electric wires can be connected in an orthogonal direction in a one-touch manner and a flow of a current can be branched in the orthogonal direction, and a connector using the same.

### BACKGROUND OF THE DISCLOSURE

In general, a method of connecting an electric wire to one or more other electric wires or connecting the end of an electric wire to a given device includes a method of stripping the sheaths of electric wires to be connected, electrically bringing exposed core of the electric wire into contact with each other by overlapping or twisting the exposed cores, and winding the exposed cores by using an insulation tape, etc.

In order to electrically interconnect two electric wires as described above, a process of exposing the core of the electric wire by stripping the sheath of the electric wire, a process of electrically interconnecting the cores, and a process of winding the cores by using an insulation tape are performed.

If two electric wires are simply twisted and electrically connected, there are problems in that the cores of the two electric wires are separated from each other over a lapse of time or due to an external force or a contact between the cores becomes poor or the surroundings of the cores are contaminated because a material having viscosity flows out from an insulation tape and a lot of time is taken to electrically connect the electric wires.

As an example of a conventional technology for solving such problems, there is suggested a terminal including components, such as a terminal connection part for electrically connecting a terminal thereof to a terminal of another electric device and a bridge connected to the terminal connection part and for connecting other electric wires.

The existing terminal has problems in that an electric wire connection task for a terminal is cumbersome and a lot of a task time is also taken because a method of manually stripping the sheath of an electric wire in order to connect the electric wire to a bridge, connecting the core of the electric wire to the bridge, and winding the connected portion by using a separate insulation tape is used, and an unexpected electrical accident occurs because a bridge and an electric wire are easily separated from each other due to a weak connection state.

In order to solve such a problem, there are suggested various methods of connecting electric wires by using a terminal having the blade of a knife and for cutting a part of the sheath of an electric wire when the sheath of the electric wire is mounted on a connector without stripping the sheath.

For example, a terminal for an electric wire connector according to a conventional technology is schematically described below. The terminal has a structure in which a cutting part is provided in an electric wire entry part on the upper side and the bottoms of a plurality of upright pieces having a core connection part and spaced apart from each other at given intervals in a length direction thereof on the lower side are integrated and connected by a connection pole.

However, such a terminal for connecting electric wires and a connector using the same according to a conventional technology have problems in that electric wires can be interconnected only in the same length direction, but electric wires bent perpendicularly to each other cannot be interconnected, an electric wire connection device generally becomes complicated because separated branch type connection means needs to be additionally used in order to connect electric wires in which a flow of a current is branched as described above, and an electric wire connection task using such a device is also cumbersome.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

An embodiment of the present disclosure provides a terminal for connecting electric wires, including a main body part having a band shape, a first connection part disposed at one end of the main body part and having a first cutting blade and a first core seated part provided therein, and a second connection part disposed at the other end of the main body part and having a second cutting blade and a second core seated part provided therein, wherein the first and second connection parts connect electric wires connected thereto, respectively, in the state in which the electric wires are intersected and arranged at a right angle to each other in a way that one of the first and second connection parts is curved at a right angle to the other of the first and second connection parts, thereby enabling the branch of a flow of a current through a simple terminal structure.

Furthermore, an embodiment of the present disclosure provides a connector using a terminal for connecting electric wires, wherein the connector has the terminal for connecting electric wires installed therein, and includes a first connector housing including a first housing base having the terminal for connecting the electric wires installed therein and electric wire arrangement parts having the electric wires disposed therein and a first housing cover covering the top of the first housing base and having electric wire seated parts corresponding to the electric wire arrangement parts; and a second connector housing including a second housing base including electric wire arrangement parts having the electric wires disposed therein and a second housing cover covering the top of the second housing base and having electric wire seated parts corresponding to the electric wire arrangement parts, so that an electric wire connection to the terminal is rapidly and conveniently performed.

Furthermore, an embodiment of the present disclosure provides a connector using a terminal for connecting electric wires, wherein any one of the first and second housing bases includes a straight arrangement part in which the electric wire is straightly disposed on any one side of the electric wire arrangement parts on the basis of connection part arrangement grooves and further includes a curved arrangement part in which the electric wire is curved with respect to the straight arrangement part on the other side of the electric wire arrangement parts, the housing cover corresponding to the housing base includes terminal location grooves for positioning the terminal disposed in the connection part arrangement grooves, the housing cover includes a straight seated part in which the electric wire is straightly seated on any one side of the electric wire seated parts on the basis of the terminal location grooves and further includes a curved seated part in which the electric wire is curved and seated with respect to the straight seated part on the other side of the electric wire seated parts, and the electric wires have one sides thereof curved on the basis of the second connection part by first and second curved seated parts and first and second curved arrangement parts, respectively, and are firmly fixed with respect to an external force in an extension direction of the electric wire.

Furthermore, an embodiment of the present disclosure provides a connector using a terminal for connecting electric wires, wherein the terminal includes a pair of first and second terminals, first connection parts of the pair of first and second terminals are disposed in parallel to each other, second connection parts of the pair of first and second terminals are curved at a right angle to each other in opposite directions, so that a width between the electric wires disposed in the first and second electric wire arrangement parts of the second housing base is widened and space utilization of the space between the electric wires is facilitated.

In an embodiment, a terminal for connecting electric wires includes a main body part having a band shape, a first connection part including a pair of first cutting blades disposed at one end of the main body part, respectively downward inclined on both sides of tops of the main body part which are spaced apart from each other at a given interval, provided at inclined tops thereof, respectively, and cutting a sheath of an electric wire that enters the pair of first cutting blades, and a first core seated part in which a core of the electric wire entering between the pair of first cutting blades is seated, and a second connection part including a pair of second cutting blades disposed at the other end of the main body part which is the other side of the first connection part, respectively downward inclined on both sides at a top of the second connection part spaced apart from each other at a given interval, provided at inclined tops thereof, respectively, and cutting a sheath of an electric wire entering therein, and a second core seated part in which a core of the electric wire entering between the pair of second cutting blades is seated. The first and second connection parts connect electric wires connected thereto, respectively, in a state in which the electric wires are intersected and arranged at a right angle to each other in a way that one of the first and second connection parts is curved at a right angle to the other of the first and second connection parts.

Furthermore, in the terminal for connecting electric wires according to an embodiment of the present disclosure, the main body part may include an electric wire layover part cut away in a way to be downward concaved on one side thereof so that the electric wire passes through the electric wire layover part without an electrical connection

Furthermore, in the terminal for connecting electric wires according to an embodiment of the present disclosure, the main body part may include a buffering groove part partially cut away on one side thereof in order to reduce the deformation of the main body part in an extension direction or a contraction direction thereof due an external force.

Furthermore, in a connector using a terminal for connecting electric wires according to an embodiment of the present disclosure, the terminal for connecting electric wires is installed in the connector, and the connector includes a first connector housing including: a first housing base, including electric wire arrangement parts which are extended along a length direction in which primary electric wires are disposed and in which wall bodies are upright and upward opened on both sides in a width direction thereof, connection part arrangement grooves in which the first connection parts of the terminals are disposed on one side of the wall bodies, and main body part penetration parts through which the main body parts of the terminals penetrate on the other side of the wall bodies, and a first housing cover, including electric wire seated parts covering the top of the first housing base and extending along a length direction thereof in a way to correspond to the electric wire arrangement parts, respectively, and entry groove parts that the wall bodies enter, respectively, on both sides in the width direction of the electric wire seated parts; and a second connector housing including: a second housing base, including electric wire arrangement parts which are extended along a length direction in which the electric wires are disposed and in which wall bodies are upright and upward opened on both sides in a width direction thereof and connection part arrangement grooves in which the second connection parts of the terminals are disposed on one side of the wall bodies, and a second housing cover, including electric wire seated parts covering the top of the second housing base and extending along a length direction thereof in a way to correspond to the electric wire arrangement parts, respectively, and entry groove parts that the wall bodies enter, respectively, on both sides in the width direction of the electric wire seated parts.

Furthermore, in the connector using the terminal for connecting electric wires according to an embodiment of the present disclosure, the first connector housing may further include a first bridge integratedly connecting the first housing base and the first housing cover.

Furthermore, in the connector using the terminal for connecting electric wires according to an embodiment of the present disclosure, the second connector housing may further include a second bridge integratedly connecting the second housing base and the second housing cover.

Furthermore, in the connector using the terminal for connecting electric wires according to an embodiment of the present disclosure, a base connection pole integratedly connecting the first housing base and the second housing base may be further provided.

Furthermore, in the connector using the terminal for connecting electric wires according to an embodiment of the present disclosure, the base connection pole may further include main body insertion groove parts downward concaved on one side thereof in a way that the main body parts of the terminals disposed from the first housing base to the second housing base are inserted and disposed therein.

Furthermore, in the connector using the terminal for connecting electric wires according to an embodiment of the present disclosure, the terminals may be provided as a pair. The electric wires corresponding to the terminals may include a pair of primary electric wires connected to the first connection parts, respectively, and a pair of secondary electric wires connected to the second connection parts, respectively, among the pair of terminals. The primary and secondary electric wires may be configured in a way to be disposed at a right angle to each other by the first and second connection parts relatively curved at a right angle.

Furthermore, in the connector using the terminal for connecting electric wires according to an embodiment of the present disclosure, the electric wire arrangement parts of the first and second housing bases may include a pair of first and second electric wire arrangement parts in which the pair of electric wires is disposed, and may further include a central wall body at the center of the first and second housing bases between the first and second electric wire arrangement parts in a way to be disposed in parallel thereof in the state in which the electric wire arrangement parts have been isolated from each other at a given interval in a width direction thereof.

Furthermore, in the connector using the terminal for connecting electric wires according to an embodiment of the present disclosure, the pair of terminals may include first and second terminals. The first terminal may be disposed so that the first core seated part of the first connection part is disposed on the same line in the first electric wire arrangement part of the first housing base and the second core seated part of the second connection part is disposed on the same line in the first electric wire arrangement part of the second housing base. The second terminal may be disposed so that the first core seated part of the first connection part is disposed on the same line in the second electric wire arrangement part of the first housing base and the second core seated part of the second connection part is disposed on the same line in the second electric wire arrangement part of the second housing base.

Furthermore, in the connector using the terminal for connecting electric wires according to an embodiment of the present disclosure, the first housing base may include trapping protrusions on one side of the outside wall body. Trapping jaw parts enabling the trapping protrusions to be trapped may be provided on one side of the first housing cover corresponding to the first housing base.

Furthermore, in the connector using the terminal for connecting electric wires according to an embodiment of the present disclosure, the second housing base may include trapping protrusions on one side of the outside wall body. Trapping jaw parts enabling the trapping protrusions to be trapped may be provided on one side of the second housing cover corresponding to the second housing base.

Furthermore, in the connector using the terminal for connecting electric wires according to an embodiment of the present disclosure, the first housing base may include guide groove parts on one side of the outside wall body. Guide protrusion parts sliding along the guide groove parts, respectively, may be on one side of the first housing cover corresponding to the first housing base.

Furthermore, in the connector using the terminal for connecting electric wires according to an embodiment of the present disclosure, the second housing base may include guide groove parts on one side of the outside wall body. Guide protrusion parts sliding along the guide groove parts, respectively, may be on one side of the first housing cover corresponding to the second housing base.

Furthermore, in the connector using the terminal for connecting electric wires according to an embodiment of the present disclosure, the second housing base may include main body arrangement groove parts which enable the main body parts of the terminals to be placed at the edges of the first and second electric wire arrangement parts in a width direction thereof in order not to hinder the arrangement of the secondary electric wires disposed in the first and second electric wire arrangement parts.

Furthermore, in the connector using the terminal for connecting electric wires according to an embodiment of the present disclosure, the second housing cover may include electric wire protrusion blocking walls for blocking the electric wire seated in the electric wire seated parts from protruding to the outside of the second housing cover at the ends of the electric wire seated parts in a length direction thereof.

Furthermore, a terminal for connecting electric wires according to an embodiment of the present disclosure includes a main body part having a band shape; a first connection part including a pair of first cutting blades disposed at one end of the main body part, respectively downward inclined on both sides at the tops of the main body part spaced apart from each other at a given interval, provided at inclined tops thereof, respectively, and cutting the sheaths of electric wires that enters the pair of first cutting blades, and a first core seated part in which the core of the electric wire between the pair of first cutting blades is seated; and a second connection part including a pair of second cutting blades disposed at the other end of the main body part which is the other side of the first connection part, respectively downward inclined on both sides at the top of the second connection part spaced apart from each other at a given interval, provided at inclined tops thereof, respectively, and cutting the sheaths of electric wires that enter the pair of second cutting blades, and a second core seated part in which the core of the electric wire between the pair of second cutting blades is seated. The first and second connection parts connect the electric wires connected thereto in the state in which the electric wires are intersected and arranged at a right angle to each other in a way that one of the first and second connection parts is curved at a right angle to the other of the first and second connection parts. The main body part further includes an electric wire layover part cut away in a way to be downward concave on one side thereof so that the electric wire passes through the main body part without an electrical connection.

Furthermore, in a connector using a terminal for connecting electric wires according to an embodiment of the present disclosure, the terminal for connecting electric wires is installed in the connector, and the connector includes a first connector housing including: a first housing base, including electric wire arrangement parts which are extended along a length direction in which the electric wires are disposed and in which wall bodies are upright and upward opened on both sides in a width direction thereof, connection part arrangement grooves in which the first connection parts of the terminal are disposed on one side of the wall bodies, and main body part penetration parts through which the main body parts of the terminal penetrate on the other side of the wall bodies, and a first housing cover, including electric wire seated parts covering the top of the first housing base and extending along a length direction thereof in a way to correspond to the electric wire arrangement parts, respectively, and entry groove parts that the wall bodies enter, respectively, on both sides in the width direction of the electric wire seated parts; and a second connector housing including: a second housing base, including electric wire arrangement parts which are extended along a length direction having the electric wires disposed therein and in which wall bodies are upright and upward opened on both sides in a width direction thereof, and connection part arrangement grooves in which the second connection parts of the terminals are disposed on one side of the wall bodies, and a second housing cover, including electric wire seated parts covering the top of the second housing base and extending along a length direction thereof in a way to correspond to the electric wire arrangement parts, respectively, and entry groove parts that the wall bodies enter, respectively, on both sides in the width direction of the electric wire seated parts. The electric wire arrangement parts of the first housing base further includes first and second electric wire arrangement parts in which a pair of primary electric wires is disposed. The electric wire arrangement parts of the second housing base corresponding to the first housing base further include first and second electric wire arrangement parts in which a pair of secondary electric wires is disposed. The pair of terminals is mounted on the first and second electric wire arrangement parts of the first and second housing bases, respectively. The primary electric wires connected to the first connection part of each terminal are connected to the secondary electric wires of the second connection part corresponding to the first connection part without a connection between the primary electric wires in the state in which electric wire layover parts of the pair of terminals have been cornerwise disposed.

Furthermore, in a connector using a terminal for connecting electric wires according to an embodiment of the present disclosure, the terminal for connecting electric wires is installed in the connector, and the terminal includes a pair of first and second terminals. The first connection parts of each of the pair of first and second terminals are disposed in parallel to each other, and the second connection parts thereof are curved at a right angle to each other in opposite directions. The connector includes a first connector housing including: a first housing base, including electric wire arrangement parts which are extended along a length direction having the electric wires disposed therein and in which wall bodies are upright and upward opened on both sides in a width direction thereof, connection part arrangement grooves in which the first connection parts of the terminals are disposed on one side of the wall bodies, and main body part penetration parts through which the main body parts of the terminals penetrate on the other side of the wall bodies, and a first housing cover, including electric wire seated parts covering the top of the first housing base and extending along a length direction thereof in a way to correspond to the electric wire arrangement parts, respectively, and entry groove parts that the wall bodies enter, respectively, on both sides in the width direction of the electric wire seated parts; and a second connector housing including: a second housing base, including electric wire arrangement parts which are extended along a length direction having the electric wires disposed therein and in which wall bodies are upright and upward opened on both sides in a width direction thereof and connection part arrangement grooves in which the second connection parts of the terminals are disposed on one side of the wall bodies; and a second housing cover, including electric wire seated parts covering the top of the second housing base and extending along a length direction thereof in a way to correspond to the electric wire arrangement parts, respectively, and entry groove parts that the wall bodies enter, respectively, on both sides in the width direction of the electric wire seated parts. The electric wire arrangement parts of the first housing base further includes first and second electric wire arrangement parts in which a pair of primary electric wires is disposed. The electric wire arrangement parts of the second housing base corresponding to the first housing base further includes first and second electric wire arrangement parts in which a pair of secondary electric wires is disposed. The pair of terminals is mounted on the first and second electric wire arrangement parts of the first and second housing bases, respectively. The primary electric wires connected to the first connection part of each terminal are connected to the secondary electric wires of the second connection part corresponding to the first connection part without a connection between the primary electric wires in the state in which electric wire layover parts of the pair of terminals have been cornerwise disposed.

Furthermore, in the connector using the terminal for connecting electric wires according to an embodiment of the present disclosure, any one of the housing bases may further include straight arrangement parts in which the electric wires are straightly disposed on any one side of the electric wire arrangement parts on the basis of the connection part arrangement grooves, and may further include curved arrangement parts in which the electric wires are curved and disposed with respect to the straight arrangement parts on the other side of the electric wire arrangement parts.

Furthermore, in the connector using the terminal for connecting electric wires according to an embodiment of the present disclosure, the housing cover corresponding to the housing base may include terminal location grooves in which the terminals disposed in the connection part arrangement grooves are disposed. The housing cover may include straight seated parts in which the electric wires are straightly seated on any one side of the electric wire seated parts on the basis of the terminal location grooves, and may further include curved seated parts in which the electric wires are curved and seated with respect to the straight seated parts on the other side of the electric wire seated parts.

As described above, the present disclosure may have effects in that product competitiveness and product reliability according to the minimization of a general manufacturing cost can be improved because a current is supplied to various places through the minimum part.

Furthermore, the present disclosure may have effects in that task efficiency and corresponding workability can be enhanced because an assembly and installation task is generally simplified and becomes fast.

Furthermore, the present disclosure may have an effect in that reliability of a product can be improved because an electric wire is prevented from being detached from the connector.

Furthermore, the present disclosure may have an effect in that workability can be improved because an electric wire connection task for the connector is facilitated.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is a perspective view illustrating a terminal for connecting electric wires according to an embodiment of the present disclosure.

FIG. 2 is a front view illustrating the terminal for connecting electric wires according to an embodiment of the present disclosure.

FIG. 3 is a perspective view illustrating a connector on which the terminal for connecting electric wires according to an embodiment of the present disclosure has been mounted.

FIG. 4 is a perspective view of the connector on which the terminal for connecting electric wires according to an embodiment of the present disclosure has been mounted, which is viewed from a different direction.

FIG. 5 is a plan view illustrating the connector on which the terminal for connecting electric wires according to an embodiment of the present disclosure has been mounted.

FIG. 6 is a side view illustrating the connector on which the terminal for connecting electric wires according to an embodiment of the present disclosure has been mounted.

FIG. 7a is a plan perspective view illustrating the state in which electric wires are connected to the connector on which the terminal for connecting electric wires according to an embodiment of the present disclosure has been mounted.

FIG. 7b is a perspective view illustrating the state in which electric wires are connected to the connector on which the terminal for connecting electric wires according to an embodiment of the present disclosure has been mounted.

FIGS. 8 to 19 are perspective views illustrating a process of sequentially connecting electric wires to the connector on which the terminal for connecting electric wires according to an embodiment of the present disclosure has been mounted.

FIGS. 20 to 22 are perspective views illustrating a terminal for connecting electric wires according to another embodiment of the present disclosure.

FIG. 23 is a plan view illustrating a terminal for connecting electric wires according to another embodiment of the present disclosure.

FIGS. 24 to 28 are perspective views illustrating a process of sequentially and continuously connecting electric wires to a connector on which the terminal for connecting electric wires according to another embodiment of the present disclosure has been mounted.

### DETAILED DESCRIPTION

While illustrative embodiments have been illustrated and described, it will be appreciated that various changes can be made therein without departing from the spirit and scope of the disclosure.

Hereinafter, embodiments of the present disclosure are described with reference to the accompanying drawings.

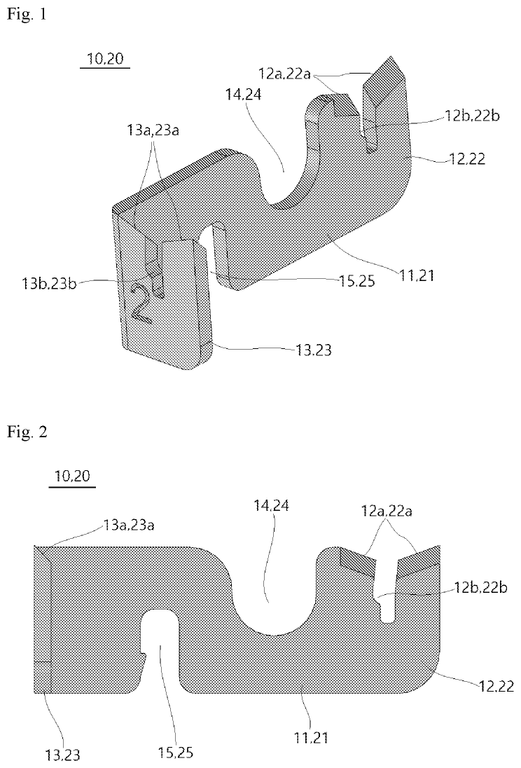

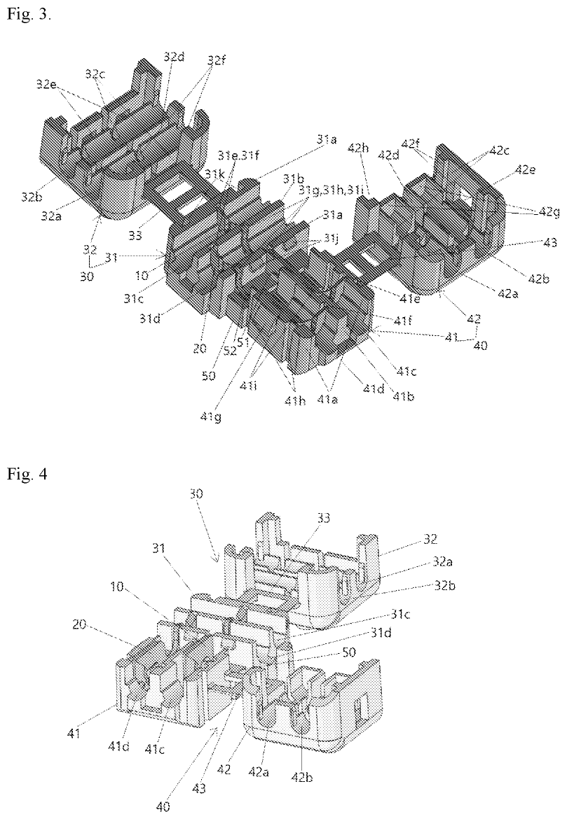

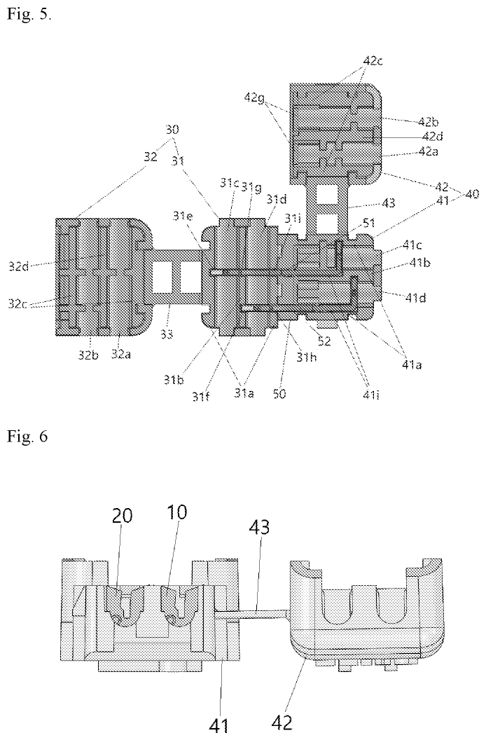

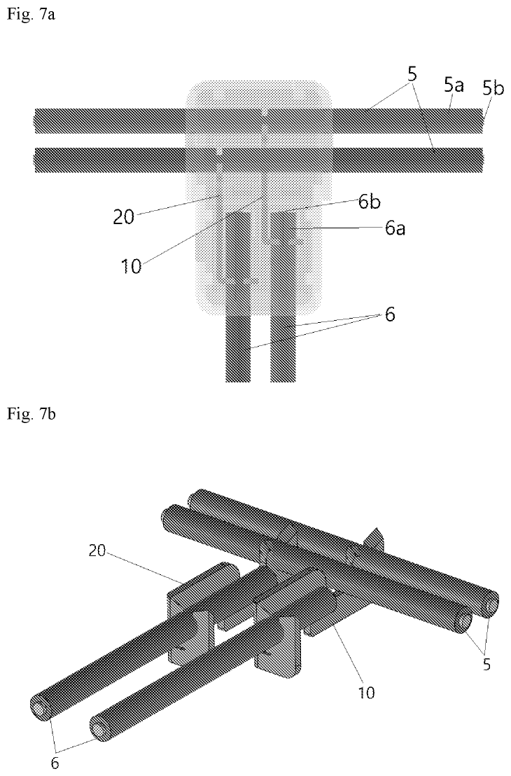

As illustrated in FIGS. 1 to 7b, a terminal 10, 20 for connecting electric wires according to an embodiment of the present disclosure includes a main body part 11, 21, a first connection part 12, 22, and a second connection part 13, 23. The first and second connection parts 12, 22 and 13, 23 have a structure in which electric wires connected to the first and second connection parts 12, 22 and 13, 23, respectively, are connected in the state in which the electric wires are intersected and arranged at a right angle to each other in a way that one of the first and second connection parts 12, 22 and 13, 23 is curved at a right angle to the other of the first and second connection parts 12, 22 and 13, 23.

The main body part 11, 21 has a rectangular band shape.

The first connection part 12, 22 has a structure including a pair of first cutting blades 12a and 22a disposed at one end of the main body part 11, 21, respectively downward inclined on both sides of the tops of the main body part which are spaced apart from each other at a given interval, provided on inclined tops thereof, respectively, and cutting a sheath 5a, 6a of an electric wire 5, 6 that enters the pair of first cutting blades, and a first core seated part 12b, 22b in which a core 5b, 6b of the electric wire 5, 6 entering between the pair of first cutting blades 12a and 22a is seated.

The second connection part 13, 23 has a structure including a pair of second cutting blades 13a and 23a disposed at the other end of the main body part 11, 21, that is, the other side of the first connection part 12, 22, respectively downward inclined on both sides at the top of the second connection part spaced apart from each other at a given interval, provided on inclined tops thereof, respectively, and cutting the sheath 5a, 6a of the electric wire 5, 6 entering therein, and a second core seated part 13b, 23b in which the core 5b, 6b of the electric wire 5, 6 entering between the pair of second cutting blades 13a and 23a is seated.

Furthermore, the main body part 11, 21 includes an electric wire layover part 14, 24 cut away in a round shape that is downward concaved on one side thereof so that the electric wire 5, 6 passes through the electric wire layover part without an electrical connection.

Furthermore, the main body part 11, 21 includes a buffering groove part 15, 25 partially cut away in a round shape on one side thereof in order to reduce the deformation of the main body part 11, 21 in an extension direction or a contraction direction thereof due an external force.

That is, when a tensile force that attracts the terminal 10, 20 on both sides of a length direction thereof is applied to the terminal by the buffering groove part 15, 25, for example, the buffering groove part 15, 25 may be slightly widened to correspond to the tensile force. Furthermore, when a contraction force that contracts the terminal 10, 20 to a central part of the length direction thereof is applied to the terminal, the buffering groove part 15, 25 may be slightly contracted to correspond to the contraction force.

A connector using the terminal 10, 20 for connecting electric wires according to an embodiment of the present disclosure has the terminal 10, 20 for connecting electric wires installed therein, and has a structure including a first connector housing 30 including a first housing base 31 and a first housing cover 32 and a second connector housing 40 including a second housing base 41 and a second housing cover 42.

The first housing base 31 of the first connector housing 30 has a rectangular block shape that is upward opened, and has a structure including electric wire arrangement parts 31c and 31d which are extended along a length direction in which primary electric wires 5 are disposed and in which wall bodies 31a and 31b are upright and upward opened on both sides in a width direction thereof, connection part arrangement grooves 31e and 31f in which the first connection parts 12 and 22 of the terminals 10 and 20 are disposed on one side of the wall bodies 31a and 31b, and main body part penetration parts 31g, 31h, and 31i through which the main body parts 11 and 21 of the terminals 10 and 20 penetrate on the other side of the wall bodies 31a and 31b.

The first housing cover 32 of the first connector housing 30 has a rectangular cover shape whose bottom is concavely opened, and has a structure including electric wire seated parts 32a and 32b covering the top of the first housing base 31 and extended along a length direction thereof in a way to correspond to the electric wire arrangement parts 31c and 31d, respectively, and entry groove parts 32c and 32d to which the wall bodies 31a and 31b enter, respectively, on both sides in the width direction of the electric wire seated parts 32a and 32b.

Furthermore, the second housing base 41 of the second connector housing 40 has a rectangular block shape that is upward opened, and has a structure including electric wire arrangement parts 41c and 41d which are extended along a length direction in which the primary electric wires 5 are disposed and in which wall bodies 41a and 41b are upright and upward opened on both sides in a width direction thereof, and connection part arrangement grooves 41e and 41f in which the second connection parts 13 and 23 of the terminals 10 and 20 are disposed on one side of the wall bodies 41a and 41b.

The second housing cover 42 of the second connector housing 40 has a rectangular cover shape whose bottom is concavely opened, and has a structure including electric wire seated parts 42a and 42b covering the top of the second housing base 41 and extended along a length direction thereof in a way to correspond to the electric wire arrangement parts 41c and 41d, respectively, and entry groove parts 42c and 42d to which the wall bodies 41a and 41b enter, respectively, on both sides in the width direction of the electric wire seated parts 42a and 42b.

Furthermore, the first connector housing 30 includes a first bridge 33 having a band shape and integratedly connecting the first housing base 31 and the first housing cover 32.

Furthermore, the second connector housing 40 includes a second bridge 43 having a band shape and integratedly connecting the second housing base 41 and the second housing cover 42.

Furthermore, a base connection pole 50 integratedly connecting the first housing base 31 and the second housing base 41 and having a lengthy rectangular pole shape is provided.

More specifically, the base connection pole 50 includes main body insertion groove parts 51 and 52 downward concaved on one side thereof so that the main body parts 11 and 21 of the terminals 10 and 20 disposed from the first housing base 31 to the second housing base 41 are inserted and disposed.

Furthermore, the terminals 10 and 20 are provided as a pair. The electric wires 5 and 6 corresponding to the terminals 10 and 20 include the pair of primary electric wires 5 connected to the first connection parts 12 and 22, respectively, and the pair of secondary electric wires 6 connected to the second connection parts 13 and 23, respectively, among the pair of terminals 10 and 20. The primary and secondary electric wires 5 and 6 has a structure in which the primary and secondary electric wires are disposed at a right angle to each other by the first and second connection parts 12, 13 and 22, 23 relatively curved at a right angle.

Furthermore, the electric wire arrangement parts 31c, 31d and 41c, 41d of the first and second housing bases 31 and 41 include the pair of first and second electric wire arrangement parts 31c, 31d and 41c, 41d in which the pair of electric wires 5 and 6 is disposed, and a central wall body 31b, 41b at the center of the first and second housing bases 31, 41 between the first and second electric wire arrangement parts 31c, 31d and 41c, 41d in a way to be disposed in parallel in the state in which the electric wire arrangement parts have been isolated from each other at a given interval in a width direction thereof.

Furthermore, the pair of terminals 10 and 20 includes first and second terminals 10 and 20, and has a structure in which the first terminal 10 is disposed so that the first core seated part 12b of the first connection part 12 is disposed on the same line in the first electric wire arrangement part 31c of the first housing base 31 and the second core seated part 13b of the second connection part 13 is disposed on the same line in the first electric wire arrangement part 41c of the second housing base 41 and the second terminal 20 is disposed so that the first core seated part 22b of the first connection part 22 is disposed on the same line in the second electric wire arrangement part 31d of the first housing base 31 and the second core seated part 23b of the second connection part 23 is disposed on the same line in the second electric wire arrangement part 41d of the second housing base 41.

Furthermore, the first housing base 31 includes trapping protrusions 31j on one side of the outside wall body 31a, and trapping jaw parts 32e each corresponding to an edge of a square through hole shape and enabling the trapping protrusions 31j to be trapped in one side of the first housing cover 32 corresponding to the first housing base 31.

Furthermore, the second housing base 41 includes a trapping protrusion 41g on one side of the outside wall body 41a, and a trapping jaw part 42e which corresponds to an edge of a square through hole shape and in which the trapping protrusion 41g is trapped on one side of the second housing cover 42 corresponding to the second housing base 41.

Furthermore, the first housing base 31 includes guide groove parts 31k each having a lengthy vertical concave groove shape on one side of the outside wall body 31a, and guide protrusion parts 32f each having a lengthy vertical protrusion shape and sliding along the guide groove parts 31k, respectively, on one side of the first housing cover 32 corresponding to the first housing base 31.

Furthermore, the second housing base 41 includes guide groove parts 41h each having a lengthy vertical concave groove shape on one side of the outside wall body 41a, and guide protrusion parts 42f each having a lengthy vertical protrusion shape and sliding along the guide groove parts 41h, respectively, on one side of the second housing cover 42 corresponding to the second housing base 41.

Furthermore, the second housing base 41 includes main body arrangement groove parts 41i which enable the main body parts 11 and 21 of the terminals 10 and 20 to be placed at edges of the first and second electric wire arrangement parts 41c and 41d in a width direction thereof in order to not hinder the arrangement of the secondary electric wires 6 disposed in the first and second electric wire arrangement parts 41c and 41d.

Furthermore, the second housing cover 42 includes electric wire protrusion blocking walls 42g each having a blocked wall body shape and for blocking the electric wire 6 seated in the electric wire seated parts 42a and 42b from protruding to the outside of the second housing cover 42 at the end of the electric wire seated parts 42a and 42b in a length direction thereof.

Furthermore, the second housing cover 42 includes a connection pole arrangement groove 42h for closely attaching the base connection pole 50 to one side thereof.

Examples in which the terminal for connecting electric wires having such a construction according to an embodiment of the present disclosure and the connector using the same are used are described as follows.

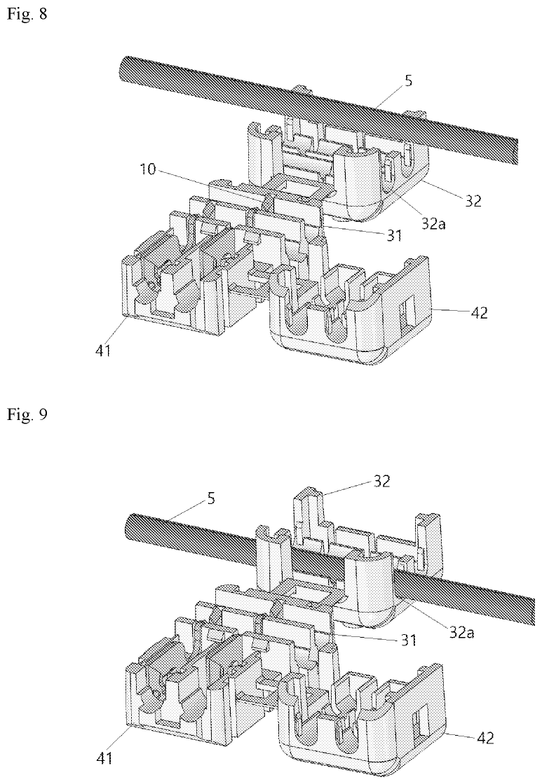

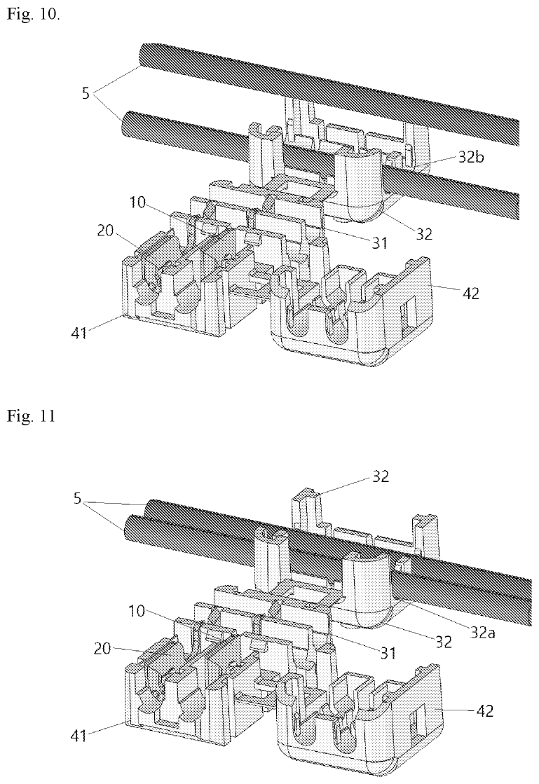

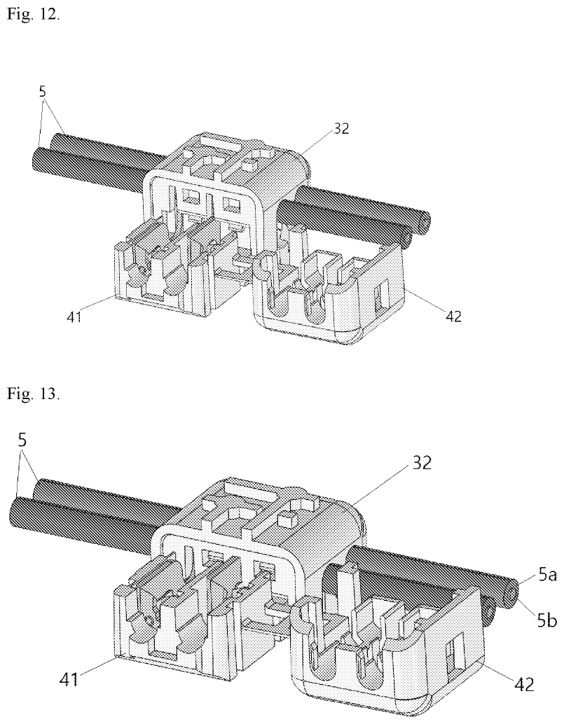

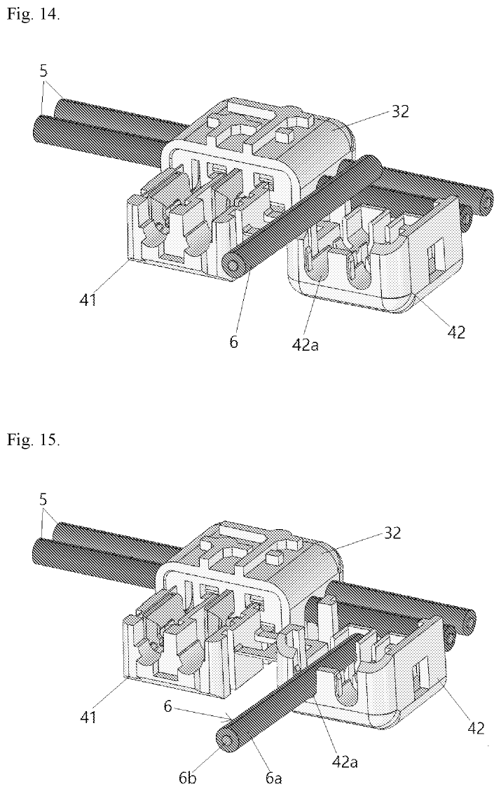

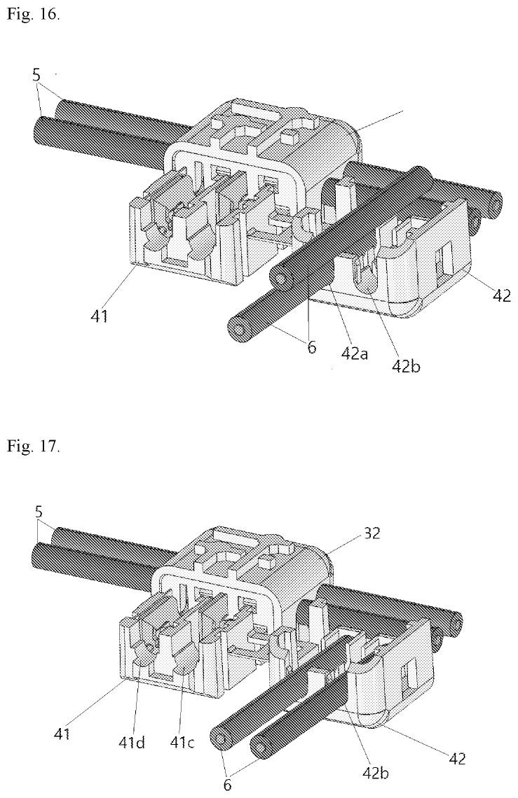

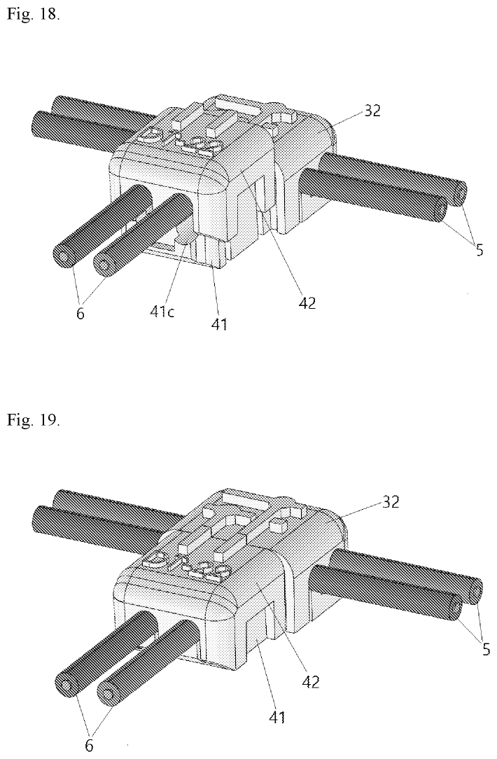

Referring to FIGS. 8 to 19, first, the first terminal 10 is disposed so that the first core seated part 12b of the first connection part 12 is disposed on the same line in the first electric wire arrangement part 31c of the first housing base 31 and the second core seated part 13b of the second connection part 13 is disposed on the same line in the first electric wire arrangement part 41c of the second housing base 41.

Furthermore, the second terminal 20 is disposed so that the first core seated part 22b of the first connection part 22 is disposed on the same line in the second electric wire arrangement part 31d of the first housing base 31 and the second core seated part 23b of the second connection part 23 is disposed on the same line in the second electric wire arrangement part 41d of the second housing base 41.

Thereafter, after the pair of primary electric wires 5 is disposed in the electric wire seated parts 32a and 32b of the first housing cover 32, the pair of primary electric wires 5 is axially rotated around the first bridge 33 and is covered on the first housing base 31.

Accordingly, in a process of the first housing cover 32 being covered on the first housing base 31, as the primary electric wires 5 are downward pressurized, the sheaths 5a of the primary electric wires 5 are cut by the first cutting blades 12a and 22a of the first connection parts 12 and 22 of the terminals 10 and 20 mounted on the first housing base 31 on the lower side thereof. At the same time, the primary electric wires 5 are downward moved, and the cores 5b within the primary electric wires 5 are seated in the first core seated parts 12b and 22b, respectively, so that the primary electric wires 5 and the first connection parts 11 and 22 are electrically connected.

In this case, the trapping protrusions 31i of the first housing base 31 are trapped in the trapping jaw parts 32e of the first housing cover 32, respectively, so that the first housing cover 32 is firmly coupled with the first housing base 31.

Thereafter, after the pair of secondary electric wires 6 is disposed in the electric wire seated parts 42a and 42b of the second housing cover 42, the pair of secondary electric wires 6 is axially rotated around the second bridge 43 and covered on the second housing base 41.

Accordingly, in a process of the second housing cover 42 being covered on the second housing base 41, as the secondary electric wire 6 are downward pressurized, the sheaths 6a of the secondary electric wire 6 are cut by the first cutting blades 13a and 23a of the second connection parts 13 and 23 of the terminals 10 and 20 mounted on the second housing base 41 on the lower side thereof. At the same time, the secondary electric wire 6 are downward moved, and the cores 6b within the secondary electric wire 6 are seated in the second core seated part 13b, 23b, respectively, so that the secondary electric wires 6 and the second connection parts 13 and 23 are electrically connected.

In this case, the trapping protrusions 41g of the second housing base 41 are trapped in the trapping jaw parts 42e of the second housing cover 42, respectively, so that the second housing cover 42 is firmly coupled with the second housing base 41.

As described above, finally, when the pairs of primary and secondary electric wires 5 and 6 are electrically connected through the pair of terminals 10 and 20 and the first and second connector housings 30 and 40, as a result, currents flowing into the primary electric wires 5 may be branched and delivered to the secondary electric wires 6 in an orthogonal direction thereof.

According to another embodiment of the present disclosure, it is evident that the first connection parts 12 and 22 and electric wire layover parts 14 and 24 of the pair of terminals 10 and 20 may be alternately and selectively continuous, several pieces of the primary electric wires 5 may be disposed without being connected with the electric wire layover parts 14 and 24 interposed therebetween, and may be then connected to the secondary electric wires 6.

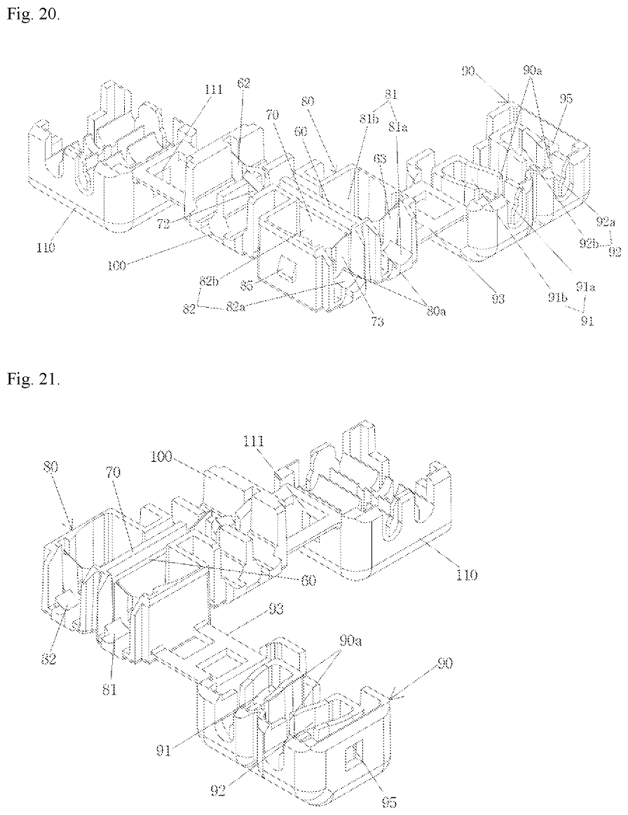

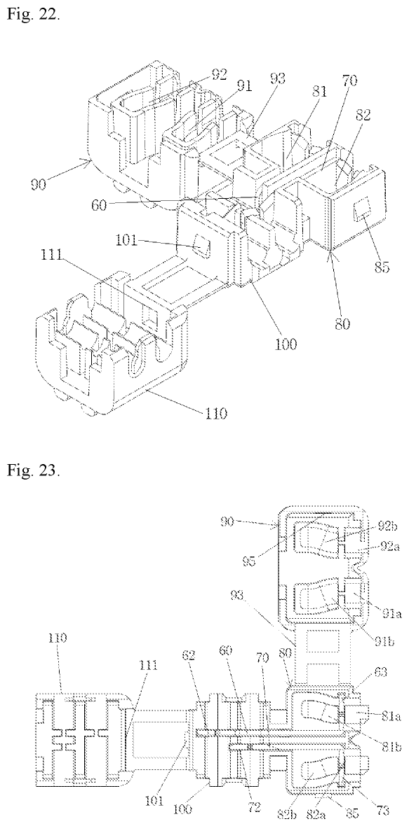

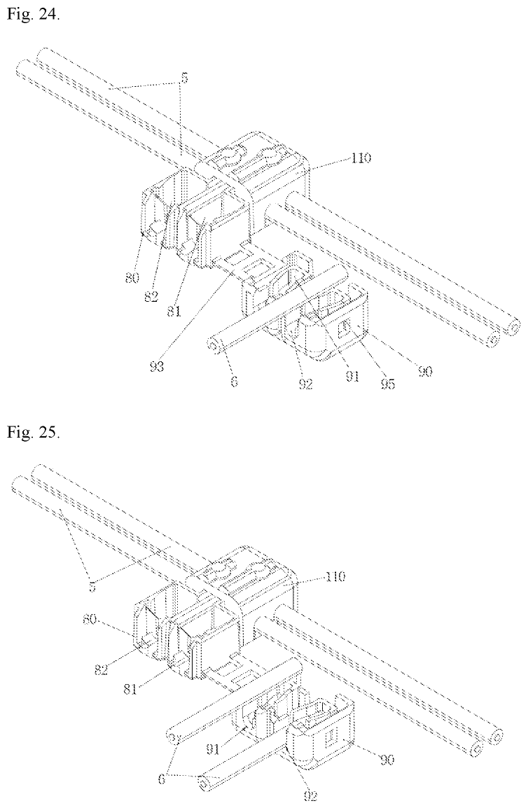

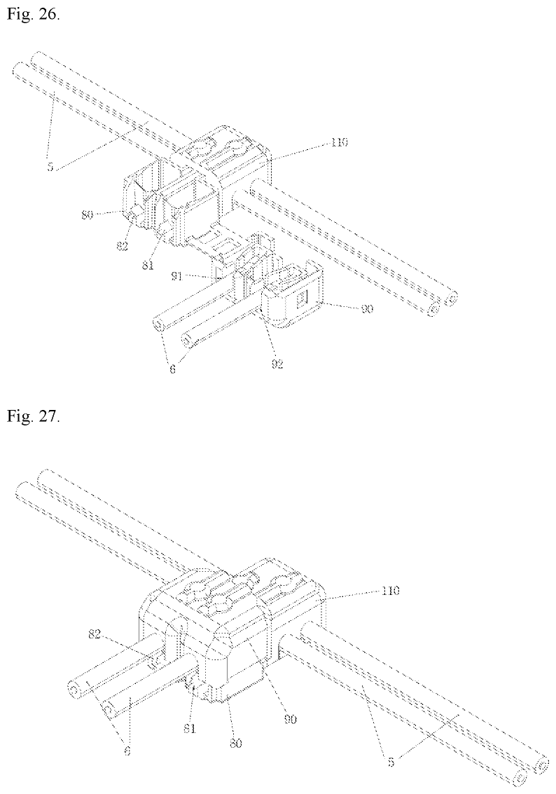

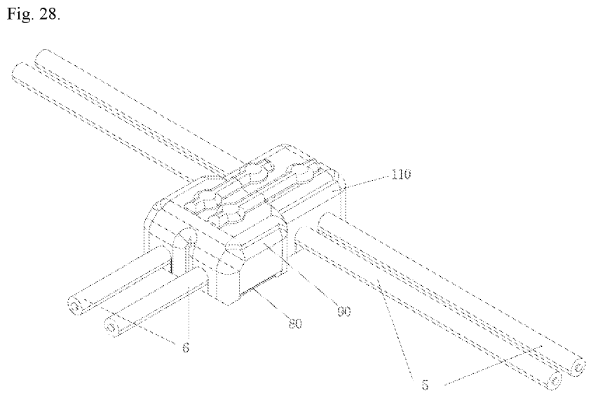

As illustrated in FIGS. 20 to 28, a connector according to still another embodiment of the present disclosure has terminals 60 and 70 for connecting electric wires installed therein. The terminal 60, 70 includes a pair of first and second terminals 60 and 70.

In this case, first and second connection parts 62, 72 and 63, 73 of the first and second terminals 60 and 70 almost have the same structures as the first and second connection parts 12, 22 and 13, 23 of the first and second terminals 10 and 20, but the pair of first and second terminals 60 and 70 is different from the first and second terminals 10 and 20 in that the first connection parts 62 and 72 are disposed in parallel to each other and the second connection parts 63 and 73 are curved at a right angle to each other in opposite directions.

Furthermore, a second housing base 80 of the housing base includes first and second straight arrangement parts 81a and 82a in which electric wires are straightly disposed on any one side of first and second electric wire arrangement parts 81 and 82 on the basis of connection part arrangement grooves 80a, and first and second curved arrangement parts 81b and 82b in which the electric wires are curved and disposed with respect to the first and second straight arrangement parts 81a and 82a on the other side of the first and second electric wire arrangement parts 81 and 82.

Furthermore, a second housing cover 90 corresponding to the second housing base 80 includes terminal location grooves 90a in which the terminals 60 and 70 disposed in the connection part arrangement grooves 80a are disposed. The housing cover 90 has a structure including first and second straight seated parts 91a and 92a in which the electric wires are straightly seated on any one side of the first and second electric wire seated parts 91 and 92 on the basis of the terminal location grooves 90a, and first and second curved seated parts 91b and 92b in which the electric wires are curved and seated with respect to the first and second straight seated parts 91a and 92a on the other side of the first and second electric wire seated parts 91 and 92.

Not-described reference numeral 101 denotes a trapping protrusion of a first housing base 100, and 111 denotes a trapping jaw part of a second housing cover 110 in which the trapping protrusions 101 is trapped fixed thereto.

An example in which a connector using the terminal for connecting electric wires having such a construction according to an embodiment of the present disclosure is described as follows.

In this case, an electric wire connection for the first housing cover 100 and the first housing base 110 is the same as that of the embodiment, and thus only electric wire connection for the second housing cover 90 and the second housing base 80 is described.

First, the first and second terminals 60 and 70 are mounted on the connection part arrangement grooves 80a of the second housing base 80, respectively.

Thereafter, after the pair of secondary electric wires 6 is disposed in the electric wire seated parts 91 and 92 of the second housing cover 90, the pair of secondary electric wires 6 is axially rotated around the second bridge 93 and covered on the second housing base 80.

Accordingly, in a process of the second housing cover 90 being covered on the second housing base 80, the secondary electric wires 6 are downward pressurized, and the sheaths of the secondary electric wires 6 are cut by the first cutting blades of the second connection parts of the terminals 60 and 70 mounted on the second housing base 80 on the lower side thereof. At the same time, the secondary electric wires 6 are downward moved, and the cores within the secondary electric wires 6 are seated on the second core seated parts, so that the secondary electric wires 6 and the second connection parts are electrically connected.

In this case, a trapping protrusion 85 of the second housing base 80 is trapped in a trapping jaw part 95 of the second housing cover 90, so that the second housing cover 90 is firmly coupled with the second housing base 80.

As described above, finally, when the pairs of primary and secondary electric wires 5 and 6 are electrically connected through the pair of terminals 60 and 70 and the second housing base 80 and second housing cover 90 of the second connector housing, as a result, currents flowing into the primary electric wires 5 may be branched and delivered to the secondary electric wires 6 in an orthogonal direction thereof.

Furthermore, the secondary electric wires 6 may be curved by the first and second curved arrangement parts 81b and 82b and the first and second curved seated parts 91b and 92b, respectively, on one side of the connection part arrangement grooves 80a, thereby firmly corresponding to an external force applied to the electric wire 6 in an extension length thereof.

1.-13. (canceled)

14. A terminal for connecting electric wires, comprising:
a main body part having a band shape;
a first connection part comprising a pair of first cutting blades disposed at one end of the main body part, respectively downward inclined on both sides of tops of the main body part which are spaced apart from each other at a given interval, provided at inclined tops thereof, respectively, and cutting a sheath of an electric wire that enters the pair of first cutting blades, and a first core seated part in which a core of the electric wire entering between the pair of first cutting blades is seated; and
a second connection part comprising a pair of second cutting blades disposed at the other end of the main body part which is the other side of the first connection part, respectively downward inclined on both sides at a top of the second connection part spaced apart from each other at a given interval, provided at inclined tops thereof, respectively, and cutting a sheath of an electric wire entering therein, and a second core seated part in which a core of the electric wire entering between the pair of second cutting blades is seated,
wherein the first and second connection parts connect electric wires connected thereto, respectively, in a state in which the electric wires are intersected and arranged at a right angle to each other in a way that one of the first and second connection parts is curved at a right angle to the other of the first and second connection parts,
the main body part comprises an electric wire layover part cut away in a downward concave round shape on one side thereof so that the electric wire passes through the main body part without an electrical connection, and
the main body part further comprises a buffering groove part partially cut away in a round shape on one side thereof in order to reduce deformation of the main body part in an extension direction or contraction direction thereof due to an external force.

15. A connector using a terminal for connecting electric wires wherein:
the terminal for connecting electric wires according to claim 14 is installed in the connector,
the connector comprises:
a first connector housing comprising:
a first housing base, comprising electric wire arrangement parts which are extended along a length direction in which primary electric wires are disposed and in which wall bodies are upright and upward opened on both sides in a width direction thereof, connection part arrangement grooves in which the first connection parts of the terminals are disposed on one side of the wall bodies, and main body part penetration parts through which the main body parts of the terminals penetrate on the other side of the wall bodies, and
a first housing cover, comprising electric wire seated parts covering a top of the first housing base and extended along a length direction thereof in a way to correspond to the electric wire arrangement parts, respectively, and entry groove parts to which the wall bodies enter, respectively, on both sides in the width direction of the electric wire seated parts; and
a second first connector housing comprising:
a second housing base, comprising electric wire arrangement parts which are extended along a length direction in which the electric wires are disposed and in which wall bodies are upright and upward opened on both sides in a width direction thereof, and connection part arrangement grooves in which the second connection parts of the terminals are disposed on one side of the wall bodies, and
a second connector housing comprising electric wire seated parts covering a top of the second housing base and extended along a length direction thereof in a way to correspond to the electric wire arrangement parts, respectively, and entry groove parts to which the wall bodies enter, respectively, on both sides in the width direction of the electric wire seated parts,
a base connection pole integratedly connecting the electric wires disposed in the first housing base and the second housing base in a way to form a right angle to each other is further provided between the first housing base and the second housing base,
the terminals are provided as a pair, the electric wires corresponding to the terminals comprise a pair of primary electric wires connected to the first connection parts, respectively, and a pair of secondary electric wires connected to the second connection parts, respectively, among the pair of terminals, and the primary and secondary electric wires have a structure in which the primary and secondary electric wires are disposed at a right angle to each other by the first and second connection parts relatively curved at a right angle,
each of the electric wire arrangement parts of the second and second housing bases comprises a pair of first and second electric wire arrangement parts in which the pair of electric wires is disposed, and
the pair of terminals comprises first and second terminals, the first terminal is disposed so that the first core seated part of the first connection part is disposed on the same line in the first electric wire arrangement part of the first housing base and the second core seated part of the second connection part is disposed on the same line in the first electric wire arrangement part of the second housing base, and the second terminal is disposed so that the first core seated part of the first connection part is disposed on the same line in the second electric wire arrangement part of the first housing base and the second core seated part of the second connection part is disposed on the same line in the second electric wire arrangement part of the second housing base.

16. The connector of claim 15, wherein the first connector housing further comprises a first bridge integratedly connecting the first housing base and the first housing cover.

17. The connector of claim 15, wherein the second connector housing further comprises a second bridge integratedly connecting the second housing base and the second housing cover.

18. The connector of claim 15, wherein:
the wall body of the first housing base comprises a pair of outside wall bodies and a central wall body disposed between the pair of outside wall bodies, and
the first housing base comprises trapping protrusions on one side of the outside wall body, and trapping jaw parts in which the trapping protrusions are trapped on one side of the first housing cover corresponding to the first housing base.

19. The connector of claim 15, wherein:
the wall body of the second housing base comprises a pair of outside wall bodies and a central wall body disposed between the pair of outside wall bodies, and
the second housing base comprises trapping protrusions on one side of the outside wall body, and trapping jaw parts in which the trapping protrusions are trapped on one side of the second housing cover corresponding to the second housing base.

20. A terminal for connecting electric wires, comprising:
a main body part having a band shape;
a first connection part comprising a pair of first cutting blades disposed at one end of the main body part, respectively downward inclined on both sides of tops of the main body part which are spaced apart from each other at a given interval, provided at inclined tops thereof, respectively, and cutting a sheath of an electric wire that enters the pair of first cutting blades, and a first core seated part in which a core of the electric wire entering between the pair of first cutting blades is seated; and
a second connection part comprising a pair of second cutting blades disposed at the other end of the main body part which is the other side of the first connection part, respectively downward inclined on both sides at a top of the second connection part spaced apart from each other at a given interval, provided at inclined tops thereof, respectively, and cutting a sheath of an electric wire entering therein, and a second core seated part in which a core of the electric wire entering between the pair of second cutting blades is seated,
wherein the first and second connection parts connect electric wires connected thereto, respectively, in a state in which the electric wires are intersected and arranged at a right angle to each other in a way that one of the first and second connection parts is curved at a right angle to the other of the first and second connection parts,
wherein the main body part comprises an electric wire layover part downward concavely cut away on one side thereof so that the electric wire passes through the main body part without an electrical connection, and
wherein the main body part further comprises a buffering groove part partially cut away in a round shape on one side thereof in order to reduce deformation of the main body part in an extension direction or contraction direction thereof due to an external force.

21. A connector using a terminal for connecting electric wires, wherein:
the terminal for connecting electric wires according to claim 20 is installed in the connector, and
the terminal comprises a pair of first and second terminals,
the first connection parts of each of the pair of first and second terminals are disposed in parallel to each other, and the second connection parts thereof are curved at a right angle to each other in opposite directions,
the connector comprises:
a first connector housing comprising:
a first housing base, comprising electric wire arrangement parts which are extended along a length direction in which primary electric wires are disposed and in which wall bodies are upright and upward opened on both sides in a width direction thereof, connection part arrangement grooves in which the first connection parts of the terminals are disposed on one side of the wall bodies, and main body part penetration parts through which the main body parts of the terminals penetrate on the other side of the wall bodies, and
a first housing cover, comprising electric wire seated parts covering a top of the first housing base and extended along a length direction thereof in a way to correspond to the electric wire arrangement parts, respectively, and entry groove parts to which the wall bodies enter, respectively, on both sides in the width direction of the electric wire seated parts; and
a second connector housing comprising:
a second housing base, comprising electric wire arrangement parts which are extended along a length direction in which the electric wires are disposed and in which wall bodies are upright and upward opened on both sides in a width direction thereof, and connection part arrangement grooves in which the second connection parts of the terminals are disposed on one side of the wall bodies; and
a second connector housing comprising electric wire seated parts covering a top of the second housing base and extended along a length direction thereof in a way to correspond to the electric wire arrangement parts, respectively, and entry groove parts to which the wall bodies enter, respectively, on both sides in the width direction of the electric wire seated parts,
the first housing base and the second housing base are integratedly connected so that the electric wires disposed in the first housing base and the second housing base form a right angle to each other,
the electric wires corresponding to the pair of terminals comprise a pair of primary electric wires connected to the first connection parts, respectively, and a pair of secondary electric wires connected to the second connection parts, respectively, among the pair of terminals, and the primary and secondary electric wires have a structure in which the primary and secondary electric wires are disposed at a right angle to each other by the first and second connection parts relatively curved at a right angle,
each of the electric wire arrangement parts of the second and second housing bases comprises a pair of first and second electric wire arrangement parts in which the pair of electric wires is disposed, and
the first terminal is disposed so that the first core seated part of the first connection part is disposed on the same line in the first electric wire arrangement part of the first housing base and the second core seated part of the second connection part is disposed on the same line in the first electric wire arrangement part of the second housing base, and the second terminal is disposed so that the first core seated part of the first connection part is disposed on the same line in the second electric wire arrangement part of the first housing base and the second core seated part of the second connection part is disposed on the same line in the second electric wire arrangement part of the second housing base.

22. The connector of claim 21, wherein any one of the housing bases comprises:
straight arrangement parts in which the electric wires are straightly disposed on any one side of the electric wire arrangement parts on a basis of the connection part arrangement grooves, and
curved arrangement parts in which the electric wires are curved and disposed with respect to the straight arrangement parts on the other side of the electric wire arrangement parts.
